(19) United States
(12) Patent Application Publication
(10) Pub. No.: US 2006/0290037 A1
(43) Pub. Date: Dec. 28, 2006

(54) Gas spring

(75) Inventors: Frank Born, Dienethal (DE); Rainer Massmann, Bonn (DE); Rolf Mintgen, Thuer (DE); Wilhelm Schwab, Neuwled (DE)

Correspondence Address: COHEN, PONTANI, LIEBERMAN & PAVANE, 551 FIFTH AVENUE, SUITE 1210, NEW YORK, NY, 10176, US

(73) Assignee: Stabilus GmbH

(21) Appl. No.: 11/193,543

(22) Filed: Jul. 29, 2005

(30) Foreign Application Priority Data
Jul. 30, 2004 (DE) 10 2004 037 474.0
Jan. 15, 2005 (DE) 10 2005 002 007.0

(51) Int. Cl. F16F 5/00

(52) U.S. Cl. 267/120; 267/124

(57) ABSTRACT

A gas spring is configured with a cylinder divided into first and second chambers by a cylinder piston provided with a rod which is displaceable within the cylinder, and a damping piston dividing the second chamber into a partial chamber and a damping chamber. The cylinder piston and damping pistons are operative to move in opposite axial push-in and push-out direction so that the damping piston is born against the piston in the push-in direction and trails the piston in the push-out direction. The gas spring further has a first choke assembly generating a greater chocking effect when both pistons move in the push-in direction than in the opposite push-out direction; and a second choke assembly generating a smaller choking effect upon displacement of the pistons in the push-in direction than in the push-out direction.

### BACKGROUND OF THE INVENTION

1. Field of the Invention

The invention relates to a gas spring.

2. Description of the Related Art

In a gas spring, it is known that the push-in and push-out movements of the piston rod have a varying characteristic outside the end damping region.

In the end damping region, varying motion characteristics are still superimposed on the push-in and push-out movements.

The object of the invention is to provide a gas spring which permits greater differentiation in both the characteristic of the push-out movement and the characteristic of the push-in movement of the piston rod.

### SUMMARY OF THE INVENTION

This object is achieved according to the present invention in that the end position damping is arranged in the second working chamber, the damping chamber facing the closed end of the cylinder and the partial chamber facing the piston, and in that, during a push-out movement of the piston rod, the choke connection between the partial chamber and the first working chamber has a smaller choke effect when the damping piston is bearing against the piston than when the damping piston is not bearing against the piston.

Thus a push-out movement is achieved which first of all starts largely undamped and then continues with normal damping.

The push-in movement is effected first of all largely undamped in order to then be damped in the end damping region.

In order to keep the damping piston in contact with the piston during the push-out movement in the end damping region, force can be applied to the damping piston in the direction of the piston by a compensating spring supported on the cylinder.

To achieve the varying damping characteristics during push-in and push-out movements of the damping piston, the damping piston, in a simple manner, on its radially encircling lateral surface, may have a radially encircling annular groove in which a damping sealing ring is arranged with axial clearance and with radial clearance relative to the base of the annular groove, this damping sealing ring bearing with its radially outer encircling lateral surface against the inner wall of the cylinder.

To produce a large cross section of flow during a displacement of the damping piston in the push-out direction, that side wall of the annular groove which faces the damping chamber preferably has apertures connecting the annular groove to the damping chamber.

Considerable damping of the push-in movement of the damping piston is effected in a simple manner by one or more damping grooves which extend at least largely over the end damping region being formed on the inner wall of the cylinder.

In this case, the effective cross section of flow of the damping grooves is smaller than the cross section of flow of the apertures.

The damping characteristic may in this case be defined non-uniformly by the damping grooves having a varying cross-sectional profile over their length.

The damping characteristic and the damping intensity may be established independently of one another for the regions of the push-out damping and the push-in damping.

The piston may have one or more nozzles connecting the first working chamber to the partial chamber.

In order to dampen the movement of the damping piston in the push-in direction to a greater extent at high speeds of the damping piston than at lower speeds, a valve connecting the damping chamber to the partial chamber is preferably arranged in the damping piston, and the closing member of this valve can be acted upon by the pressure in the damping chamber in such a way that it can be moved from its open position into its closed position against a spring force.

To this end, in a simple design, the closing member is a closing slide displaceably arranged in a cylindrical guide opening, and one or more axially extending control grooves are formed in the cylindrical wall of the guide opening.

If the closing slide is of pot-like design and its radially encircling orifice margin can be put onto an annular valve seat of the damping piston, this saves weight and construction space while the closing slide is effectively guided.

In this case, the spring force acting on the closing slide can be exerted by a compression spring supported on the damping piston and projecting into the interior of the closing slide.

Furthermore, an axially continuous nozzle bore may be arranged in the closing member.

In order to avoid heavy striking of the piston against the damping piston, the damping piston can preferably be acted upon in a displaceable manner by the piston via an elastically deformable buffer element.

If the elastic buffer element is arranged in a pot-shaped recess in the damping piston, the opening of this recess being directed towards the piston, this saves space and provides for ease of assembly.

For the normal damping of the push-out movement, one or more damping grooves extending between the end damping region and the piston-rod-side end may be arranged on the inner wall of the cylinder in a simple manner.

A varying damping characteristic over the push-out path is achieved by the damping grooves having a varying cross-sectional profile over their length.

In this case, if the damping grooves are reduced in their cross section at their end opposite the end damping region, an increase in damping is effected at the end of the push-out movement in order to avoid heavy striking in the end position.

To open up a large cross section of flow during a push-in movement and to shut off this cross section of flow during a push-out movement, the piston may be enclosed by a sealing ring which bears with its outer radially encircling lateral surface against the inner wall of the cylinder, and under which flow can occur at its radially inner annular region and which can be moved with axial clearance between two stops, the piston being sealed off relative to the inner wall of the cylinder when the sealing ring bears against the stop closer to the damping piston.

In order to also obtain a large cross section of flow in a simple manner in the end damping region during a push-out movement, the sealing ring, when the damping piston is acted upon axially by the piston, is preferably lifted from that stop of the piston which is closer to the damping piston.

To this end, the damping piston may have an axial stop which is directed towards the piston and by means of which the sealing ring can be lifted from that stop of the piston which is closer to the damping piston.

Another possibility consists in the sealing ring having a projecting axial stop which is directed towards the damping piston and can be placed axially against the damping piston.

However, it is also possible for an axially magnetized first permanent magnet to be arranged on the sealing ring, a further permanent magnet arranged on the damping piston being located axially opposite this first permanent magnet, the like poles of the first permanent magnet and the further permanent magnet facing one another.

As long as the damping piston is located at least close to the piston, the like poles, repelling one another, of the permanent magnets cause the sealing ring to lift from that stop of the piston which is closer to the damping piston.

To open a large cross section of flow from the partial chamber to the first working chamber during a push-out movement in the end damping region, a valve may be arranged in the piston, which valve, when the piston is acted upon axially by the damping piston, is open in such a way as to connect the partial chamber to the first working chamber.

In a simple manner, the valve is in this case a seat valve, the valve member of which can be lifted from its valve seat by the damping piston.

As an alternative thereto, however, the piston may consist of a first piston part which is fastened to the piston rod and is enclosed by an annular second piston part which is displaceable coaxially relative to the first piston part and carries the sealing ring, having an annular seal which encloses a cylindrical section of the first piston part with clearance and which, with its radially inner region, can be brought axially into tight contact with an annular shoulder, projecting towards the second piston part, of the first piston part and which, with its radially outer region over which flow can occur, can be brought axially into tight contact with an annular shoulder, projecting towards the first piston part, of the second piston part, it being possible for the annular shoulder of the second piston part, when it is acted upon axially by the damping piston, to be moved away from the annular shoulder of the first piston part in such a way as to connect the partial chamber to the first working chamber.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the invention are shown in the drawing and are described in more detail below. In the drawings:

FIG. 1 shows a gas spring of the present invention in longitudinal section with a piston and a damping piston,

FIG. 2 shows a cross section of the cylinder of the gas spring of the present invention according to FIG. 1 in the end damping region,

FIG. 3 shows a cross section of a second exemplary embodiment of a piston in accordance with the present invention,

FIG. 4 shows a cross section of a third exemplary embodiment of a piston, in accordance with the present invention

FIG. 5 shows a cross section of a fourth exemplary embodiment of a damping piston in accordance with the present invention at low push-in speed,

FIG. 6 shows the damping piston according to FIG. 5 at high push-in speed,

FIG. 7 shows a cross section of a second exemplary embodiment of piston and damping piston,

FIG. 8 shows a cross section of a third exemplary embodiment of piston and damping piston,

FIG. 9 shows a cross section of a fourth exemplary embodiment of piston and damping piston,

FIG. 10 shows a cross section of a fifth exemplary embodiment of piston and damping piston,

FIG. 11 shows a motion characteristic of a tailgate, which can be driven by a gas spring, of a motor vehicle.

### DETAILED DESCRIPTION OF THE PRESENTLY PREFERRED EMBODIMENTS

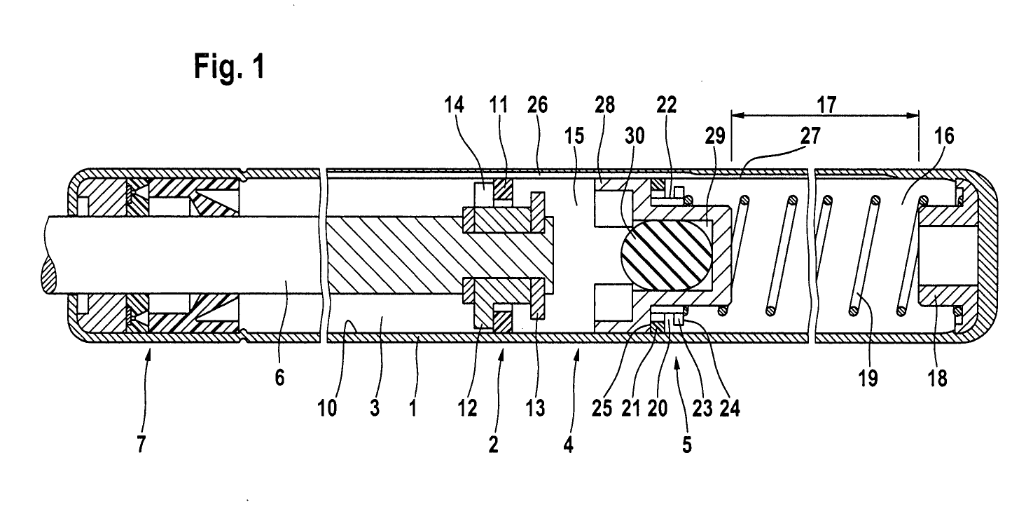

The gas spring in FIG. 1 has a cylinder 1 which is closed on one side and is filled with a pressurized gas.

The interior space of the cylinder 1 is subdivided by a piston 2 into a first working chamber 3 and a second working chamber 4. Fastened on one side to the piston 2 is a piston rod 6, which is led out of the cylinder 1 at the end opposite the closed end in a sealed-off manner by a sealing and guide assembly 7.

The cylinder is linked at its closed end to a fixed part (not shown) of a body of a motor vehicle, whereas that end of the piston rod 6 which is led out of the cylinder 1 is linked to a tailgate 8 (FIG. 11), pivotable about a pivot axis 9, at a distance from the pivot axis 9.

The piston 2 is enclosed by a sealing ring 11 which bears with its outer radially encircling lateral surface against the inner wall 10 of the cylinder 1 and has a low friction resistance relative to the inner wall 10 of the cylinder 1. The sealing ring 11 is designed as a rectangular ring. However, its function can also be fulfilled by another sealing ring, such as a groove ring or an O-ring for example.

Flow can occur under the sealing ring 11 at its radially inner annular region and it is axially movable with axial clearance between a stop 12 on the piston-rod side and a stop 13 further away from the piston rod.

When the sealing ring 11 bears against the stop 13, the piston 2 is sealed off relative to the inner wall 10 of the cylinder 1. If the sealing ring 11 is lifted from the stop 13, gas can flow under it, and this gas flows from the second working chamber 4 into the first working chamber 3.

To avoid a substantial flow resistance, the stop 12 has axial passages 14 of large cross section.

The second working chamber 4 is subdivided by a damping piston 5 into a partial chamber 15 close to the piston and a damping chamber 16 remote from the piston, and the damping piston 5 can be displaced in the closed end region of the cylinder 1, which forms an end damping region 17.

Force is applied to the damping piston 5 in the direction of the piston 2 by a low-force compensating spring 19 supported on the closed end of the cylinder 1 via a supporting part 18, so that the damping piston 5 bears against the piston 2 within the end damping region 17. Outside the end damping region 17, the piston 2 lifts from the damping piston 5.

On its radially encircling lateral surface, the damping piston 5 has a radially encircling annular groove 20 in which a damping sealing ring 21 is arranged with axial clearance and with radial clearance relative to the base 22 of the annular groove 20.

Flow can thus occur under the damping sealing ring 21.

With its radially outer encircling lateral surface, the damping sealing ring 21 bears against the inner wall of the cylinder 1.

The annular groove 20 is connected to the damping chamber 16 via apertures 23 in that side wall 24 of the annular groove 20 which is closer to the damping chamber 16.

When the damping sealing ring 21 bears axially against that side wall 25 of the annular groove 20 which is closer to the piston 2, the damping piston 5 is sealed off relative to the inner wall 10 of the cylinder 1.

A damping groove 27 of smaller cross section extending over the end damping region 17 is formed on the inner wall 10 of the cylinder 1.

Between the end damping region 17 and approximately the piston-rod-side end of the cylinder 1, a damping groove 26 is formed on the inner wall 10 of the latter, which damping groove 26 has a larger cross section than the damping groove 27 and gradually runs out with reducing cross section (not shown) at its end opposite the end damping region 17.

The damping piston 5 has an annular stop 28 which is directed axially towards the piston 2 and by means of which the sealing ring 11 is lifted from the stop 13 when the damping piston 5 bears against the piston 2, so that, by flowing under the sealing ring 11, gas can flow from the partial chamber 15 to the first working chamber 3 largely without any resistance.

Formed in the damping piston 5 is an axial pot-shaped recess 29, the opening of which is directed towards the piston 2 and in which a roughly spherical elastically deformable buffer element 30 is inserted which projects axially from the opening.

When piston 2 and damping piston 5 travel towards one another, first of all an elastic deformation of the buffer element 10 occurs before piston 2 and damping piston 5 come to bear against one another.

When tailgate 8 is closed, it is located in the bottom position shown in FIG. 11. The piston rod 6 is retracted and holds the damping piston 5 in its position next to the closed end of the cylinder 1.

When a lock (not shown) of the tailgate 8 is released, the piston 2, on account of its larger effective area on the side remote from the piston rod 6, is moved in the extension direction by the gas pressure. In the process, due to the compensating spring 19, the damping piston 5 first of all remains in contact with the piston 2, so that its stop 28 keeps the sealing ring 11 lifted from the stop 13. Thus, by flowing under the sealing ring 11 and by flowing over the sealing ring 11 at the damping groove 26, gas can flow largely unimpaired from the first working chamber 3 to the partial chamber 15 and the piston 2 can be displaced largely undamped in the extension direction of the piston rod 6.

The damping piston 5 moves together with the piston 2 over the first part I of this stroke, which corresponds to the end damping region 17.

In the process, the damping seal 21 bears against the side wall 24, so that, by flowing under the damping seal 21 and by flowing over in the damping groove 27, gas can flow largely unimpaired from the partial chamber 15 into the damping chamber 16.

When the damping piston 5 has reached the piston-side end of the end damping region 17, it stops. By the piston 2 continuing to move, the stop 28 lifts from the sealing ring 11, so that the latter shifts and comes to bear against the stop 13, as a result of which a flow under the sealing ring 11 is interrupted.

Normal damping of the extension movement now takes place in the following part 11 of the stroke, during which extension movement gas can only flow via the damping groove 26 from the first working chamber 3 to the partial chamber 15.

That end of the damping groove 26 which decreases in cross section leads to smooth end damping in part III of the stroke.

If the tailgate 8 is now moved downwards again manually from its maximum raised position in the closing direction, no perceptible damping is effected in parts IV and V of the stroke, since the sealing ring 11 is now displaced into contact with the stop 12, so that flow can again occur under it and gas can flow largely unimpaired from the partial chamber 15 into the first working chamber 3.

If the piston now comes to bear against the damping piston 5, the latter has to be displaced with it in the retraction direction. In the process, the damping sealing ring 21 bears against the side wall 25 of the annular groove 20 and blocks a flow under the damping sealing ring 21. A flow of gas from the damping chamber 16 into the partial chamber 15 or into the first working chamber 3 is only possible via the damping groove 27, so that part VI of the stroke up to the latching in place in the lock is effected in a damped manner.

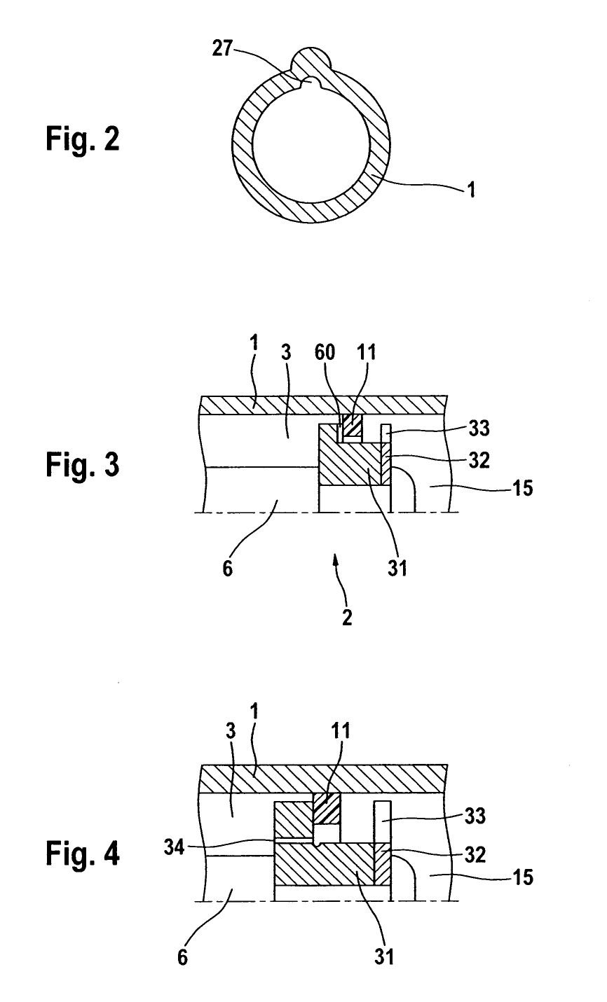

The exemplary embodiment of a piston 2 shown in FIG. 3 consists of an annular piston part 31 whose annular groove accommodating the sealing ring 11 is designed to be open on one side towards the partial chamber 15 at the radially encircling lateral surface of the piston part 31. The stop 13 is formed by an annular disc 32 which has apertures 33. The piston part 31 and annular disc 32 are arranged on the small step of the piston rod 6, of step-shaped design at one end, by clinching its free end. Formed in the stop 12 are radial grooves 60, by means of which the first working chamber 3 is connected to the partial chamber 15 when the sealing ring 11 bears against the stop 12.

With the exception of the grooves 60, the exemplary embodiment in FIG. 4 has the same construction as the exemplary embodiment in FIG. 3. Instead of the grooves 60, nozzles 34 are formed in the piston part 31, these nozzles 34 connecting the base region of the annular groove to the first working chamber 3.

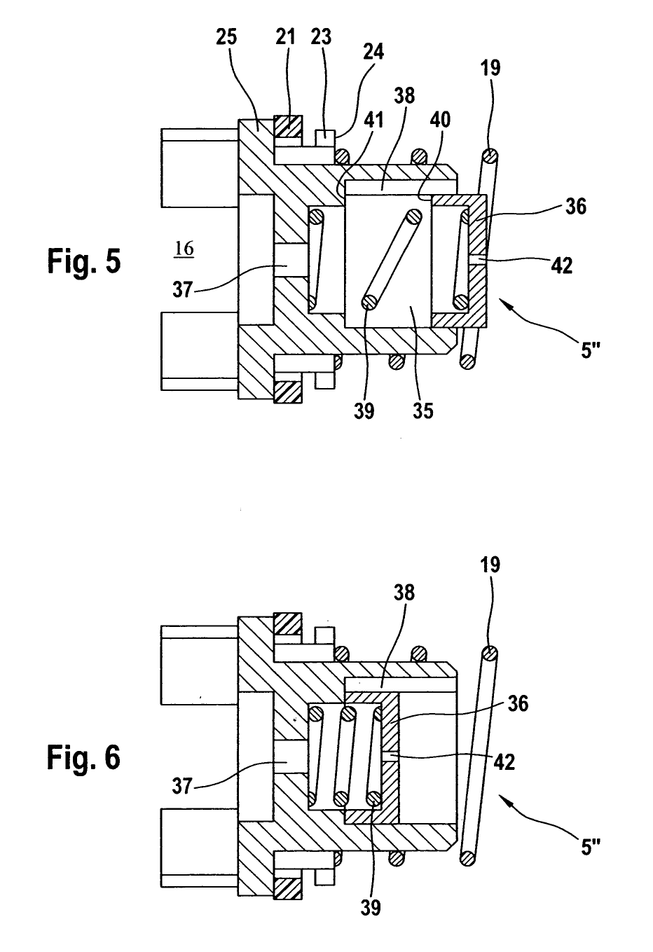

The damping piston 5″ according to FIGS. 5 and 6 is provided with a coaxial pot-like guide opening 35, the opening of which is directed towards the damping chamber 16 and in which a likewise pot-like closing slide 36 is displaceably arranged. Via an opening 37 in the base of the guide opening 35, the latter is connected to the partial chamber 15.

An axially extending control groove 38 opening into the damping chamber 16 is formed in the cylindrical wall of the guide opening 35.

A compression spring 39 is supported on the base of the guide opening 35 and acts upon the closing slide 36, which is directed with its radially encircling annular orifice margin 40 towards the base of the guide opening 35.

The base of the guide opening 35 is of stepped design, the radially outer step forming an axially directed annular shoulder 41, against which the orifice margin 40, when closing slide 36 is pushed in against the force of the compression spring 39 by the pressure of the damping chamber 16, comes to bear (FIG. 6) and shuts off a connection of the damping chamber 16 via the control groove 38, the guide opening 35 and the opening 37 to the partial chamber 15.

Only a small throughflow of gas is then possible via a nozzle bore 42 formed coaxially in the base of the closing slide 36.

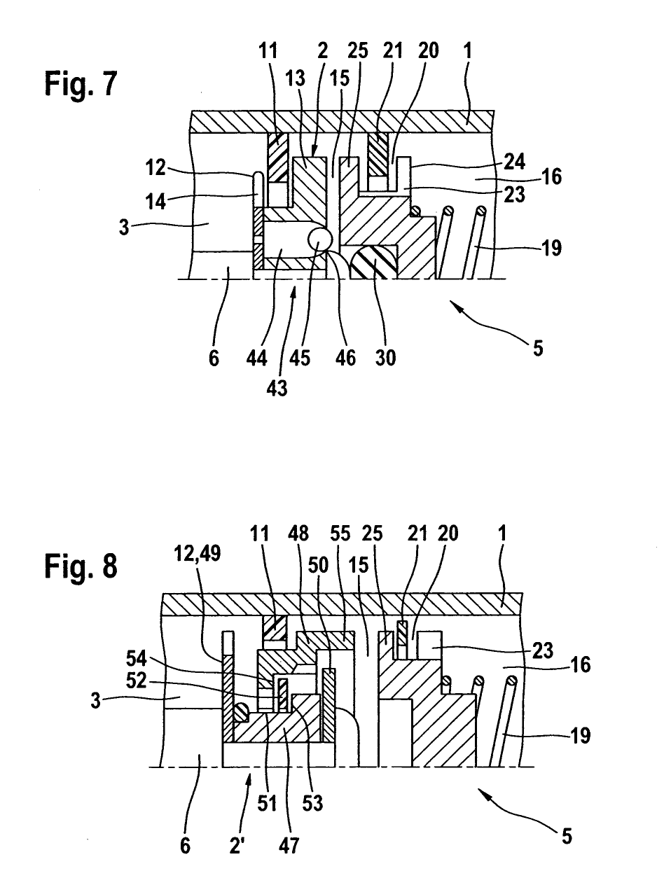

According to FIG. 7, as an alternative to the stop 28 in FIG. 1 which lifts the sealing ring 11 from the stop 13, a seat valve 43 can be formed in the piston 2 in a passage 44 from the partial chamber 15 to the first working chamber 3, the valve member 45 of this seat valve 43 being lifted from its valve seat 46 by the damping piston 5 when the latter bears against the piston 2.

A further possibility for such a function is shown in FIG. 8. There, the piston 2′ consists of a first piston part 47 fastened to the piston rod 6. This first piston part 47 is enclosed by an annular second piston part 48 which is displaceable coaxially relative to the first piston part 47 and also carries the sealing ring 11. The axial displaceability of the second piston part 48 on the first piston part 47 is limited by two stop discs 49 and 50 arranged on the piston rod 6. The stop ring 49 at the same time forms the stop 12 for the sealing ring 11.

A cylindrical section 51 of the first piston part 47 is enclosed with clearance by an annular seal 52 which, with a side of its radially inner region, can be brought axially into tight contact with an annular shoulder 53, projecting towards the second piston part 48, of the first piston part 47.

With its other side, the seal 52, at its radially outer region over which flow can occur, can be brought axially into tight contact with an annular shoulder 54, projecting towards the first piston part 47, of the second piston part 48.

During an extension movement of the piston 2′ outside the end damping region 17, the second piston part 48 is displaced relative to the first piston part 47 in the direction of the partial chamber 15. As a result, both annular shoulders 53 and 54 come to bear against the seal 52 and shut off a connection from the partial chamber 15 to the first working chamber 3, at which connection flow can occur under and over the seal 52.

An annular extension 55 of the second piston part 48 projects axially towards the damping piston 5 and is acted upon axially by the latter in the end damping region 17 in such a way that the second piston part 48 is displaced relative to the first piston part 47 in the direction of the first working chamber 3. The annular shoulders 53 and 54 thus lift from the seal 52, so that the flow path from the first working chamber 3 to the partial chamber 15 is open.

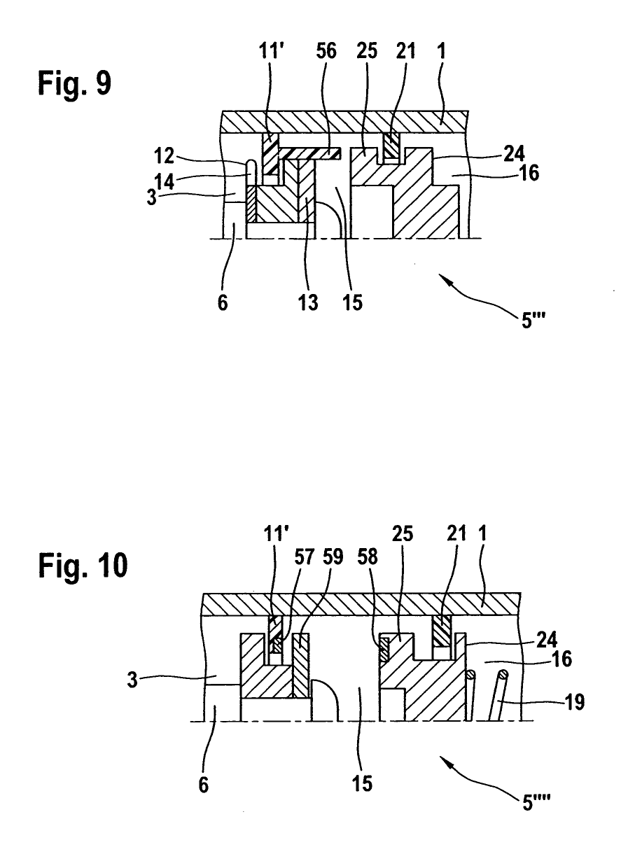

In the exemplary embodiment in FIG. 9, as a kinematic reversal with respect to the exemplary embodiment in FIG. 1, instead of a stop 28 of the damping piston 5, a projecting axial stop 56 directed towards the damping piston 5′″ is arranged on the sealing ring 11′, and this stop 56 can be acted upon axially by the damping piston 5′″ and can be lifted from the stop 13.

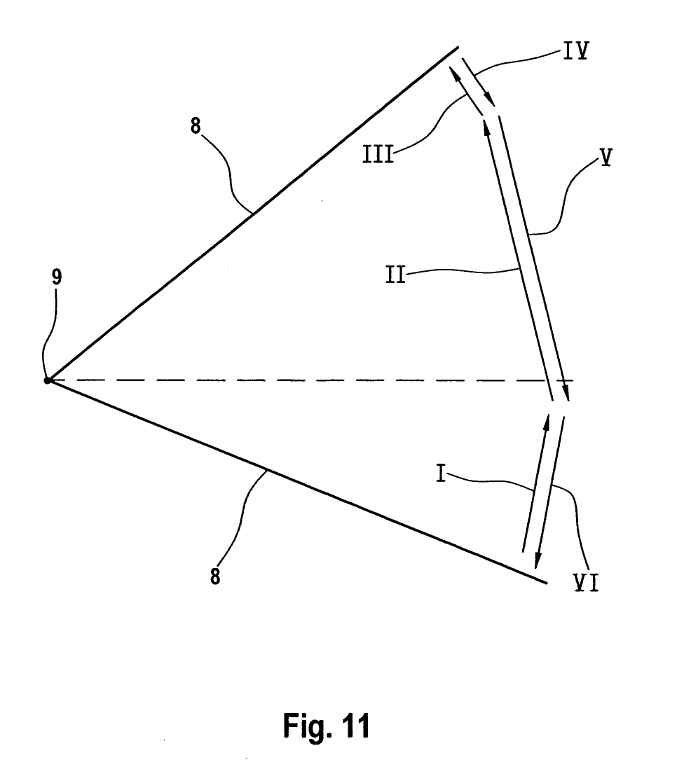

A further alternative is shown in FIG. 10. There, an axially magnetized first permanent magnet 57 is arranged on the sealing ring 11″, a second permanent magnet 58 arranged on the damping piston 5″″ being located axially opposite this first permanent magnet 57.

The stop 13 is formed by a stop disc 59 made of a material which does not disturb the magnetic field of the permanent magnets 57 and 58.

Since those poles of the permanent magnets 57 and 58 which face one another are like poles, the permanent magnets 57 and 58 are repelled when they are close to one another when piston 2 and damping piston 5″″ bear against one another, which is the case in the end damping region 17. As a result, the sealing disc 11″ is moved away from the stop disc 59 into its open position.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A gas spring comprising:
a cylinder filled with pressurized gas and having axially spaced sealed and closed ends;
a rod reciprocally displaceable in the cylinder in axially opposite push-in and push-out directions, one of opposite rod ends extending through the sealed end from within the cylinder, and the other rod extending within the cylinder;
a cylinder piston fastened to the other rod end so that the cylinder piston and the sealed end of the cylinder define a first chamber, and the piston cylinder and the closed end of the cylinder define a second chamber;
a damping piston mounted in and dividing the second chamber into a partial chamber and a damping chamber so that the partial chamber is defined between the cylinder and damping pistons, and the damping chamber is between the damping piston and the closed end of the cylinder, the damping piston being born against the cylinder piston along an end damping region towards the closed end of the cylinder upon displacing of the rod in the push-in direction and trailing the cylinder piston along the end damping region upon displacing the rod in the push-out direction;
a first choke connection located between the partial and damping chambers and operable to generate a greater chocking effect when the damping piston is born against the cylinder piston in the push-in direction than when the damping piston trails the cylinder piston in the push-out direction;
a second choke connection located between the partial chamber and the first chamber and operable to generate a smaller choking effect when the damping piston is born against the cylinder piston in the push-in direction during displacement of the rod in the push-in direction than when the damping piston trails the cylinder piston in the push-out direction.

2. The gas spring of claim 1, further comprising a compensating spring located between the closed end of the cylinder and the damping piston so as to bias the damping piston in the push-out direction towards the cylinder piston.

3. The gas spring of claim 1, wherein an outer periphery of the damping piston and an inner periphery of the cylinder define an annular encircling groove, the first choke connection having:
a sealing ring axially displaceable in the annular groove and having an outer surface born against the inner periphery of the cylinder and an inner surface radially spaced from the outer periphery of the damping piston.

4. The gas spring of claim 3, wherein the sealing ring has apertures providing flow communication between the damping chamber and the annular groove.

5. The gas spring of claim 1, wherein an inner periphery of the cylinder has a damping groove axially extending at least along the end damping region.

6. The gas spring of claim 5, wherein the damping groove has a non-uniformly shaped cross-section over a length thereof.

7. The gas chamber of claim 1, wherein the cylinder piston comprises a nozzle providing flow communication between the first chamber and the partial chamber.

8. The gas spring of claim 1, further comprising a valve mounted to the damping piston and a compensating spring braced against the damping piston and the closed end of the cylinder, the valve comprising a closing member operable to move in the push-in direction against a force of the compensating spring from an open position of the valve, in which the partial and damping chambers are in flow communication, to a closing position of the valve in which flow communication between the partial and damping chambers is blocked during displacement of the cylinder and damping pistons in the push-in direction.

9. The gas spring of claim 8, wherein the damping piston has an inner wall defining a cylindrical guide opening and provided with a plurality of axially extending control grooves, the cylindrical guide opening being configured to displaceably receive the closing member, wherein the closing member is a closing slide.

10. The gas spring of claim 9, wherein the closing slide has an outer surface provided with a pot-shaped cross-section, the outer surface of the closing slide being supported in an annular valve seat of the damping cylinder.

11. The gas spring seat of claim 9, wherein the closing member has an axially continuous nozzle bore opening into the damping chamber.

12. The gas spring of claim 1, further comprising an elastically deformable buffer element extending between the damping and cylinder pistons and resting thereagainst upon displacement of the cylinder piston in the push-in direction so as to displaceably connect the cylinder and damping pistons.

13. The gas spring of claim 12, wherein the damping piston has a pot-shaped recess opening into the partial chamber and configured to receive the buffer element.

14. The gas spring of claim 5, wherein the damping groove extends between the end damping region and a piston rod side of the piston cylinder.

15. The gas spring of claim 5, wherein the damping groove has a non-uniformly shaped cross-section over a length thereof.

16. The gas spring of claim 1, further comprising:
two axially spaced apart radial stops extending between an outer periphery of the cylinder piston and an inner periphery of the cylinder so as to define a space therebetween,
the second choking connection comprising an annular sealing ring mounted within the space and having an outer surface and an inner surface, the outer surface of the sealing ring being sealingly born against the inner periphery of the cylinder, and an inner surface of the sealing ring being configured to define a passage with the outer periphery of the cylinder piston traverseable by flow of the pressurized gas,
the sealing ring being axially displaceable towards one of the two radial stops located next to the damping chamber and resting thereagainst so as to seal off the cylinder piston relative to the inner periphery of the cylinder.

17. The gas spring of claim 16, wherein the sealing ring is lifted from one radial stop when the cylinder piston and the damping piston are born against one another during displacement thereof in the push-in direction.

18. The gas spring off claim 17, wherein the damping piston comprises an annular axial stop extending towards the cylinder piston and configured to press against the sealing ring so as to lift the sealing from the one radial stop when the cylinder piston and damping pistons are born against one another in the push-in direction.

19. The gas spring of claim 17, wherein the sealing ring comprises an axial stop spaced radially from the inner periphery of the cylinder, the axial stop projecting towards the damping piston and pressing thereagainst so as to lift the sealing ring from the one radial stop of the cylinder piston when the cylinder piston and damping pistons are born against one another in the push-in direction.

20. The gas spring of claim 17, wherein the sealing ring and damping piston have first and second permanent magnets spaced axially apart and arranged so that like charged poles of the first and second permanent magnets face one another.

21. The gas spring of claim 16, further comprising a valve coupled to the cylinder piston so that when the cylinder piston and the damping piston born against one another during displacement thereof in the push-in direction, the valve is open so as to provide flow communication between the partial and first chambers.

22. The gas spring of claim 21, wherein the valve comprises a seat and a valve closing member operative to be lifted from the valve seat by the damping piston when the cylinder piston and damping piston are born against one another in the push-in direction.

23. The gas spring of claim of claim 1, wherein the cylinder piston comprises a first piston part fastened to the rod and a second piston part radially surrounding the first piston part so that the first and second piston parts axially displaceable relative to one another, the first and second parts having respective axially extending cylindrical surfaces each formed with a shoulder, the shoulders radially extending towards one another and being spaced axially apart so as to define a space therebetween,
the second choke connection comprising:
a sealing ring extending between the second piston part and an inner periphery of the cylinder, and
an annular seal supported upon the cylindrical surface of the first piston part within the space and radially extending towards and terminating at a distance from the cylindrical surface of the second piston part, the annular seal being sandwiched between the shoulders of the first and second piston parts upon displacing the cylinder piston in the push-in direction so as to block flow communication between the first and partial chambers, the second piston part being actuated by the damping piston upon displacement thereof in the push-out direction so as to provide flow communication between the first and partial chambers upon axially displacing the shoulder of the second piston parts from the annular seal.
